(19) United States
(12) Patent Application Publication
(10) Pub. No.: US 2010/0315463 A1
(43) Pub. Date: Dec. 16, 2010

(54) SERVICING PRINT HEADS IN PRINTING SYSTEMS

(76) Inventors: Daniel Blanch Escude, Barcelona (ES); Marta Coma Vives, Barcelona (ES); Ainhca Urbistondo Galarraga, Barcelona (ES)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/485,852

(22) Filed: Jun. 16, 2009

(51) Int. Cl. B41J 2/165

(52) U.S. Cl. 347/33

(57) ABSTRACT

Systems and methods for servicing print heads of a printing system are disclosed. The printing system may include a print head, a web impregnated with a liquid configured to form a protective coating on the print head when the print head contacts the web, and a roller configured to place the web adjacent the print head, wherein the print head is configured to move among a plurality of positions including a proximal position in which the print head contacts the web, and a distal position in which the print head is spaced from the web.

### BACKGROUND

Printing systems, such as inkjet printers, include one or more print heads. Each print head includes a printing surface having a series of nozzles that are used to spray drops of ink. During operation of the printing systems, the printing surface of the print head(s) may accumulate contaminants, such as dried ink or drying ink. Those contaminants may severely affect the print quality of the printing system.

Printing systems typically include service stations that, among other things, periodically clean the printing surface of the print head. The service stations may include a dry web of wiping material that is pressed against the printing surface to clean the print head via friction. Some inks, such as latex inks (or latex polymer containing inks), are difficult to remove via friction, particularly when those inks have dried or crusted on the printing surface of the print head.

### BRIEF DESCRIPTION OF THE DRAWINGS

FIG. 1 is a block diagram of a printing system in accordance with an embodiment of the disclosure.

FIG. 2 is a block diagram showing a service station of the printing system of FIG. 1 in accordance with an embodiment of the disclosure.

FIG. 3 is a perspective view of an example of a print head assembly of the printing system of FIG. 1, and in accordance with an embodiment of the disclosure.

FIG. 4 is an end view of an example of a roller of the service station of FIG. 2, and in accordance with an embodiment of the disclosure.

FIG. 5 is a partial side view of an example of a service station of the printing system of FIG. 1, the service station shown in a static wiping mode in accordance with an embodiment of the disclosure.

FIG. 6 is a partial side view of an example of a service station of the printing system of FIG. 1, the service station shown in a dynamic wiping mode in accordance with an embodiment of the disclosure.

FIG. 7 is a partial side view of an example of a service station of the printing system of FIG. 1, the service station shown in a spitting/priming mode in accordance with an embodiment of the disclosure.

FIG. 8 is a flow chart showing an example of a method of servicing a print head in accordance with an embodiment of the disclosure.

### DETAILED DESCRIPTION

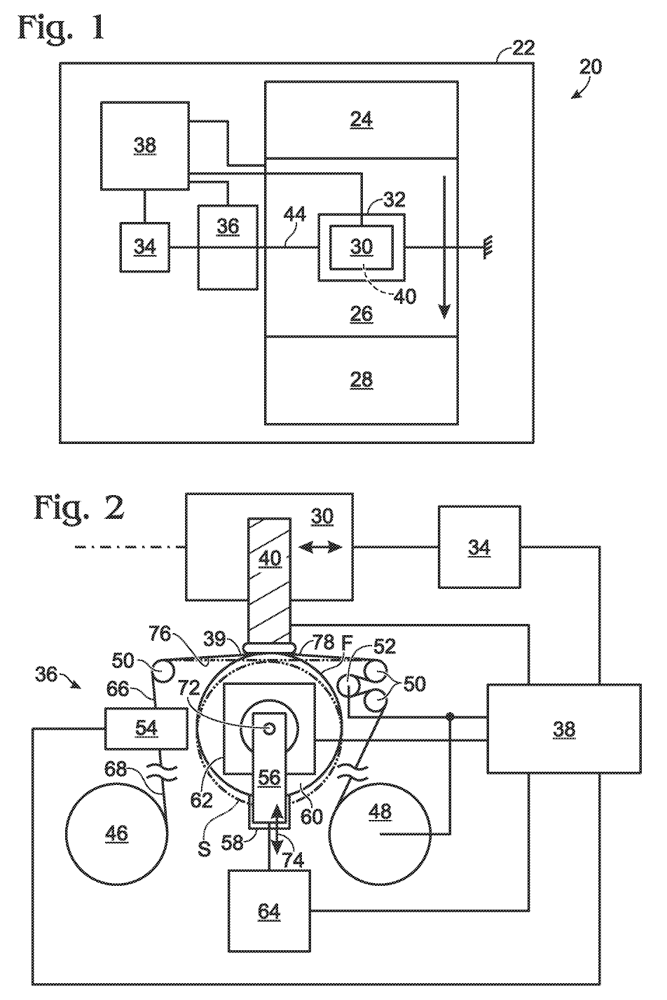

FIG. 1 shows a printing system 20. The printing system may include a housing 22, an input assembly 24 a transport assembly 26, an output assembly 28, a print head assembly 30, a carriage assembly 32, a print head actuator 34, a service station 36 and a controller 38. Input assembly 24 may include any suitable structure supported by housing 22 and configured to store and deliver media to transport assembly 36. For example, where the media includes sheets of one or more materials, input assembly 24 may include a tray or bin. Additionally, where the media is applied as part of a roll, input assembly 24 may include a supply roll of media.

Transport assembly 26 may include any suitable structure configured to receive the media from input assembly 24, to deliver or move the media relative to print head assembly 30 and/or to subsequently move the printed upon media to output assembly 28. For example, where the media includes sheets of material, transport assembly 26 may include a series of rollers, belts, movable trays, a drum, robotic arms and/or the like. Additionally, transport assembly 26 may include other mechanisms configured to grasp or hold the media as it is moved with respect to the print head assembly.

Output assembly 28 may include any suitable structure configured to receive printed-upon media from transport assembly 26. For example, the output assembly may be configured to provide a person with access to the printed-upon media. Additionally, output assembly 28 may be configured to be connected to another device or transport for moving the printed-upon media to another mechanism for further interaction and/or treatment. Output assembly 28 may include a tray or bin. Although printing system 30 is shown to include input assembly 24, transport assembly 26 and output assembly 28, the printing system may exclude one or more of those assemblies, such as where the media is manually positioned with respect to print head assembly 30.

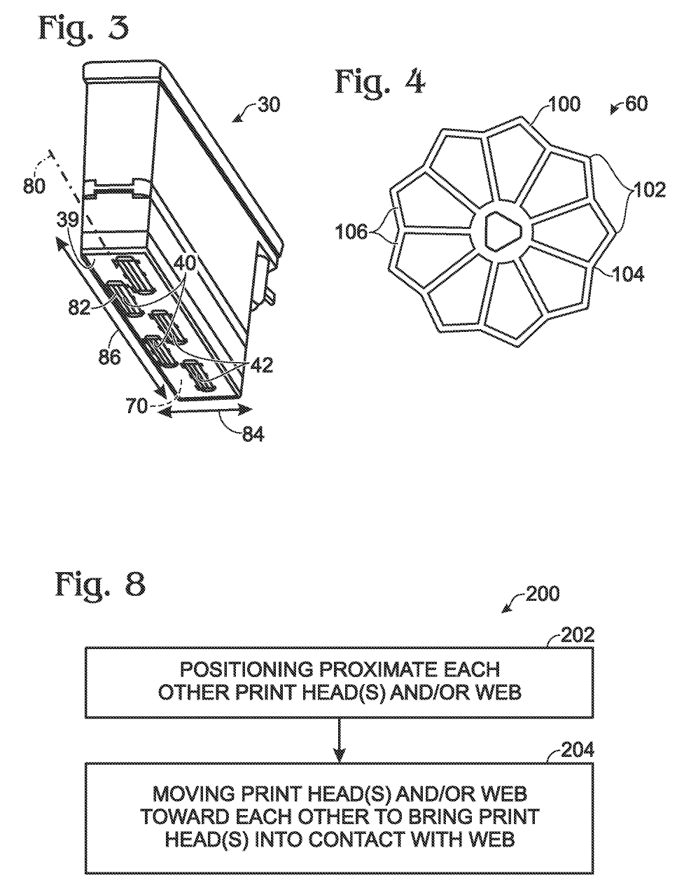

Print head assembly 30 may include a printing surface 39 with at least one print head 40 having a plurality of nozzles 42 through which fluid, such as ink, is ejected, as shown in FIG. 3. Print head(s) 40 may include thermoresistive print heads. Alternatively, or additionally, the print head(s) may include piezo or piezoelectric print heads. Print head(s) 40 may be part of a cartridge which also stores the fluid to be dispensed. Alternatively, or additionally, the print head(s) may be supplied with fluid by an off-axis ink supply. Although print head assembly 30 is shown to include five print heads 40, the print head assembly may include any suitable number of print heads.

Carriage assembly 32 may include any suitable structure movably supporting print head assembly 30. For example, the carriage assembly may be configured to slide or move along a guide 44, such as a rod, bar and/or rack gear. The carriage assembly may be configured to removably receive the print head assembly. Alternatively, or additionally, the carriage assembly may have other configurations.

Print head actuator 34 may include any suitable structure operatively connected to carriage assembly 32 and configured to move the carriage assembly and/or the print head assembly among a plurality of positions, including a printing position in which print head assembly 30 is located opposite or adjacent to a media positioned by transport assembly 26, and one or more service positions in which the print head assembly is located opposite or adjacent to service station 36 for servicing of print head(s) 40 of the print head assembly. The service positions may include a proximal position P in which the print head(s) come into contact with a web of the service station, and a distal position D in which the print head(s) are spaced from the web of the service station (further discussed below). The print head actuator may include a motor operatively connected to print head assembly 30 by a drive train and/or transmission. Additionally, the print head actuator may include an electric solenoid and/or hydraulic or pneumatic cylinder assembly.

Service station 36 may include any suitable structure configured to service print head(s) 40 of the print head assembly to enhance printing performance of print system 30 while maintaining printing throughput. Examples of servicing operations include coating, wiping, spitting and/or priming. FIG. 2 shows an example of service station 36. The service station may include a web supply 46, a web take-up 48, web supports 50, a web drive 52, a web retainer 54) a roller support 56, a roller guide 58, a roller 60, a roller retainer 62, and a web actuator 64.

Web supply 46 and web take-up 48 may be configured to facilitate use of a web of cleaning or wiping material 66 (also referred to as a “web”). Web 66 may include a continuous length of flexible material configured to be brought into contact with and/or pressed against nozzles 42 of print head(s) 40 to service those print head(s). Web 66 may include non-woven polymeric or non-polymeric materials that may be configured to absorb liquid. For example, web 66 may include a non-woven polymeric material, such as EVOLON commercially available from Freudenberg Group of Freudenberg & Co. of Weinheim an der Bergstrasse, Germany. Alternatively, or additionally, web 66 may include a woven material. Web 66 may be removable and/or replaceable. For example, the web may be stored on a roll that may be installed on web supply 46.

Web 66 also may be impregnated with one or more liquids 68 configured to form a protective coating 70 on the print head(s) and/or clean the print head(s) when the web contacts and/or presses against the print head(s). The protective coating may humidify the printing surface of the print head(s) to slow down drying of the ink. Additionally, the protective coating may act as a barrier such that dried ink is accumulated on the coating and not on the printing surface of the print head(s). When dried ink and/or drying ink accumulates on the protective coating, the protective coating and the ink on that coating may be removed by the web contacting and/or pressing against the print head(s). Web 66 may be impregnated with the liquid at any suitable concentrations.

The web may be impregnated prior to operation of the printing system. In other words, impregnation of the web with the liquid may not occur in the service station. For example, when the web comes in a roll that is installed in the web supply of the service station, the roll may already have been impregnated prior to that installation, such as a pre-impregnated roll available from a chemical and/or web supplier and/or a roll impregnated in a separate system spaced from the printing system. Alternatively, the web may be impregnated with the liquid during servicing operations prior to the web contacting and/or pressing against the print head(s).

Liquid 68 may have any suitable properties configured to form a protective coating 70 on the print head(s) and/or clean the print head(s). Liquid 68 may have a boiling point substantially greater than room temperature, such as greater than about 200° C., or preferably greater than about 250° C., or more preferably greater than about 290° C. to prevent evaporation of the liquid during operation of the printing system. Additionally, the liquid may have a sufficient viscosity and/or surface tension such that the liquid remains in the web and flows out of the web only when the web contacts and/or is pressed against the printing surface of the print head(s). For example, liquid 68 may have a viscosity of about 70 centipoise (cP) at 25° C. or preferably about 90 cP at 25° C.

Liquid 68 may, for example, include any suitable solvent having one or more of the properties discussed above, such as polyethylene glycol. Any suitable commercial grades of polyethylene glycol may be used, such as PEG 300, PEG 400, etc. PEG 300 and PEG 400 may be available from various chemical suppliers, including JMN Specialties, Inc. of Westwego, LA and Optimal Group of Companies of Kuala Lumpur, Malaysia. The polyethylene glycol may be in any suitable concentration in web 66 that allows the web to coat the print head(s) sufficiently without over-coating those print head(s), which would affect operation of the nozzles and affect print quality. Specifically, the suitable concentration of polyethylene glycol in web 66 may be about 0.025 to about 0.004 grams per square centimeter (g/cm²), or preferably about 0.025 to about 0.00714 g/cm², or even preferably at about 0.0125 g/cm². Although liquid 68 is discussed to include polyethylene glycol, the liquid may alternatively, or additionally, include one or more other solvent(s) and/or other types of liquids, with one or more of the properties discussed above.

Web supply 46 may include a spool or roll of substantially clean and unused, wiping material or web 66, which may be Impregnated with liquid 68. Web take-up 48 may include a spool or spindle about which used web 66 is wound. Web take-up 48 may be maintained under controlled tension. Web supports 50 may include one or more rollers and/or other structures configured to extend web 66 such that the web spans, for example, two of supports 50 across roller 60. The web supports may maintain the web in tension during wiping of print head(s) 40. Although service station 36 is illustrated as including three such supports in the form of rollers in the illustrated arrangement, service station 36 may have greater or fewer of supports 50. Additionally, the supports may include other structures and/or may be provided in other arrangements.

Web drive 52 may be configured to drive web 66 from web supply 46 across roller 60 to web take-Lip 48. The web drive may engage the web between supports 50 and/or may include a motor rotationally driving a roller in engagement with web 66. Web drive 52 may further be operatively connected to web take-up 48 by a gear transmission, a slip clutch and/or a torsional spring (not shown). The torsional spring, which may only wind to a certain tension depending on the setting of the slip clutch, may maintain web take-up 48 at a controlled tension. The slip clutch may be driven passively by the powertrain from web drive 52. Although web drive 52 is shown to include particular mechanisms to drive web 66 and/or web take-up 48, other mechanisms may be used.

Web retainer 54 may include any suitable structure configured to appropriately inhibit movement of web 66 when it contacts print head(s) 40 and/or when print head(s) 40 are being moved relative to roller 60 by web actuator 64. The web retainer may reduce an amount of the web that is dragged and/or unwound from web supply 46 during such wiping, coating and/or cleaning. For example, web retainer 54 may include a passive web brake using a one-way clutch. Additionally, the web retainer may selectively be actuatable between a plurality of states, including a web braking or retaining active state in which unwinding of web 66 from supply 46 may be inhibited, and an inactive state in which the web may more easily be unwound from supply 46, such as when web take-up 48 is moving web 66 across the print head(s). Although service station 36 is shown to include a particular web retainer 54, the service station may include a web retainer having other configurations.

Roller support 56 may include any suitable structure configured to rotationally support roller 60 about an axis 72. Roller guide 58 may include any suitable structure configured to cooperate with roller support 56 so as to guide movement of the roller support to facilitate translation of roller 60 and the axis about which the roller rotates in the directions indicated by arrows 74. The roller support may thus facilitate translation of roller 60 toward and/or away from a portion of web 66 that spans between web supports 50 and print head(s) 40. Although roller guide 58 is illustrated as linearly translating roller 60 in a single direction perpendicular to the web and the print head(s), the roller guide may be configured to facilitate translation of roller 60 along multiple linear segments and/or along an arcuate path toward or away from the web and the print head(s). Additionally, roller support 56 may be stationary or fixed while rotationally supporting roller 60 for rotation about axis 72.

Roller 60 may include an elongate substantially cylindrical member extending along and rotationally supported about axis 72. Roller 60 may be configured to contact and be pressed against a first side 76 of web 66 while being located opposite to print head(s) 40 so as to urge and press a second side 78 of material 70 into contact with nozzles 42 of the print head(s). Roller 60 may be configured to bring the web into contact with printing surface 39 and/or press web 66 against the printing surface to wipe, clean and/or coat the printing surface. Additionally, the roller may be configured to move across and/or parallel with the printing surface. When web 66 is used to wipe the printing surface, wiping across the printing surface may be referred to as “cross wiping” and wiping parallel to the printing surface may be referred to as “parallel wiping,” Additionally, when web 66 is used to coat the printing surface, coating across the printing surface may be referred to as “cross coating” and coating parallel to the printing surface may be referred to as “parallel coating.”

FIG. 3 shows an example of print head assembly 30 with five staggered individual print heads 40 having nozzles 42. Print heads 40 extend along one or more central axes which are parallel to or coincident with a longitudinal axis 80 of print head assembly 30. The print head assembly may, however, include greater or fewer of such individual print heads 40, which may or may not be staggered and may not be parallel. During movement of the roller across the printing surface, web 66 interacts with that surface (such as with nozzle plates 82 that define nozzles 42) in the direction indicated by arrow 84 to cross wipe or cross coat the printing surface. In contrast, during movement of the roller parallel to the printing surface, web 66 interacts with that surface in the direction indicated by arrow 86 to parallel wipe or parallel coat the printing surface.

During servicing of nozzles 42, roller 60 may bring web 66 into contact with the nozzles and/or may press the web against the nozzles. Roller 60 may be resiliently compressible in a radial direction, which may provide the roller with some “give” to reduce the likelihood of excessive and, potentially damaging, forces being applied to print head(s) 40. For example, roller 60 may be formed from a resiliently compressible foam or sponge material. Alternatively, or additionally, roller 60 may be formed from one or more polymer materials, which may provide the roller with enhanced durability. The roller may have a substantially uniform outer circumferential surface extending 360 degrees about axis 72.

Alternatively, or additionally, roller 60 may have an irregular surface providing particular pressure points for supplying precise points of pressure to printing surface 39, such as to nozzles 42. For example, roller 60 may include a multitude of radially extending ribs or projections. Such projections may be in the form of extending points or teeth, circumferentially spaced bumps or dimples, helically or spirally extending projections, grooves or teeth and/or the like. Additionally, roller 60 may have a cross-sectional shape including two or more lobes. Although roller 60 is shown to be resiliently compressible and/or flexible, the roller may be inflexible or incompressible or may have other configurations.

An example of roller 60 is shown in an end view in FIG. 4 and is generally indicated at 100. Roller 100 may include a non-uniform outer circumferential surface. Additionally, the roller may include projections 102 and low points 104. Projections 102 may have a decreased contact area, which may provide higher local pressures for the same force. Additionally, the projections may extend along substantially an entire axial length of roller 100. The roller also may include a pair of substantially planar segments 106 between projections 102 that gradually incline or ramp from low points 104 to projections 102. The roller in FIG. 4 also may be referred to as a “star-shaped roller.”

Roller retainer 62 may include any suitable structure configured to selectively inhibit or substantially retain roller 60 against rotation about axis 72. For example, the roller retainer may be configured to retain the roller in one or more predetermined angular positions, wherein features (such as projections) along a surface of the roller have predetermined positions with respect to print head(s) 40. As a result, positional control over such features of roller 60 may be achieved. For example, where the roller includes radially extending projections, such projections may be positioned and/or retained correctly opposite to print head(s) 40 to reduce a likelihood of damage to print head(s) 40. Alternatively, or additionally, such projections may be positioned and/or retained so as to not extend opposite to or minimally extend opposite to the print head(s), such as when the print head(s) are being moved by web actuator 64 across the roller.

Roller retainer 62 may include a pair of keys or a pair of corresponding projections and detents which may be selectively engaged to lock roller 60 against rotation. Additionally, roller retainer 62 may be configured to lock or retain the roller in a selected one of many different potential angular orientations. For example, roller retainer 62 may include a selectively actuatable clutch. Moreover, the roller retainer may be actuated among a plurality of states, including a retaining state and a released state, permitting rotation of roller 60, in response to control signals from controller 38. Furthermore, roller retainer 62 may actuate between the retaining state and the released state in response to positioning the roller and the roller support by web actuator 64.

Web actuator 64 may include any suitable structure operatively connected to roller support 56 and configured to move or translate that support and roller 60 among a plurality of positions. For example, the web actuator may move the roller between two positions: a first position F in which the roller contacts and/or presses web 66 against print head(s) 40, such as when the print head(s) are in the proximal position, and a second position S in which the roller disengages and/or spaces the web from the print head(s), such as when the print head(s) are in the proximal position. Additionally, the web actuator may move the roller in a position in which the roller is spaced from the web. Web actuator 64 may be configured to translate roller support 56 and roller 60 to a plurality of positions. The amount of pressure pressing web 66 against print head(s) 40 may Vary depending upon the positioning of roller 60 by web actuator 64.

Web actuator 64 may include one or more hydraulic or pneumatic cylinder-piston assemblies and electric solenoids. Additionally, the web actuator may include a motor operatively connected to a pinion gear in engaging with a rack gear associated with roller support 56. Alternatively, or additionally, the actuator may include a motor operatively connected to a cam in engagement with a cam follower associated with the roller support. Although specific examples of web actuator 64 are described above, the actuator may have other configurations. Alternatively, or additionally, roller 60 may be supported against web 66 in a fixed or permanent fashion without the opportunity for the translation of roller support 56. Although printing system 30 is illustrated as including multiple distinct actuators, such as print head actuator 34 and web actuator 64, the supply of torque or force from such actuators may be consolidated in a fewer number of actuators that employ an appropriate number of drive trains or transmissions to transmit torque or force to each of the recipients.

Controller 38 may include one or more processing units configured to generate control signals directing the operation of transport assembly 267 print head assembly 307 print head actuator 34, and/or service station 36. With respect to the service station, controller 38 may generate control signals directing the operation of web drive 52, web retainer 54, roller retainer 62, and/or web actuator 64. As noted above, where the roller retainer is actuated between different states by the web actuator, controller 38 may indirectly control roller retainer 62 by controlling the web actuator.

“Processing unit,” as used herein, includes a presently developed or future developed processing unit that executes sequences of instructions contained in a memory. Execution of the sequences of instructions may cause the processing unit to perform steps, such as generating control signals. The instructions may be loaded in a random access memory (RAM) for execution by the processing unit from a read only memory (ROM), a mass storage device, and/or some other persistent storage. Additionally, hard wired circuitry may be used in place of or in combination with software instructions to implement the functions described. For example, controller 38 may be embodied as part of one or more application-specific integrated circuits (ASICs). Unless otherwise specifically noted, the controller is not limited to any specific combination of hardware circuitry and software, or to any particular source for the instructions executed by the processing unit.

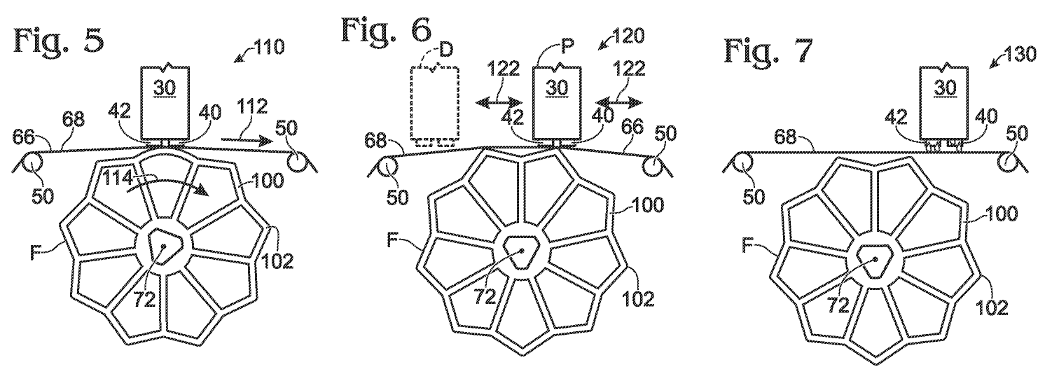

FIGS. 5-7 show examples of different print head servicing modes (also may be referred to as “primitives”) that may be performed by service station 36. Although a particular roller 60 is shown in the form of roller 100, the printing system may include any suitable roller 60. FIG. 5 illustrates a static mode 110. In such a static mode, print head 40(S) may be substantially stationary as web 66 is moved across nozzles 42 as indicated by arrow 112. Additionally, roller 100 may be translated to a position opposite or proximate to print head(s) 40 by the web actuator and the roller retainer may be in an inactive state. As a result, roller 100 may be compressed as it presses web 66 against nozzles 42. As discussed above, projections 102 may provide a higher peak pressure and larger average pressure across a smaller area with the same amount of force, enhancing servicing of nozzles 42, such as wiping, cleaning and/or coating. As indicated by arrow 114, as web 66 is pulled across the roller, the roller, which is in an idling state, may rotate from torque applied by the movement of web 66. As a result, projections 102 may be swept across nozzles 42 of print head(s) 40.

FIG. 6 shows a dynamic mode 120 wherein the print head actuator may move print head 40 across web 66 and across the roller as indicated by arrow 122 (i.e., between distal position D and proximal position P). The web actuator may have previously moved roller 100 into first position F such that the roller presses web 66 against nozzles 42 to effectuate servicing, and preferably for cleaning and coating the print head(s). During such a dynamic mode, the angular positioning of the roller retainer may be controlled and set to a predetermined orientation. In particular, the roller retainer may set the angular positioning of roller 100 with respect to axis 72. Additionally, the roller retainer may set the angular positioning or orientation of the roller such that peaks of projections 102 facing web 66 are at their lowest points with respect to the web.

The predetermined angular orientation of roller 100 may be established when or while the roller is in a lowered position out of engagement with web 66. For example, the angular orientation of roller 100 is indexed to a certain orientation by the roller retainer when lowered into engagement with an indexing structure of the roller retainer. Although the roller may be disengaged from the indexing structure when raised) the angular orientation of the roller may be maintained until the roller is brought into engagement with web 66. Because the web is in tension over projections 102 that are at their lowest points, web 66 may inhibit rotation of roller 100. Alternatively, or additionally, roller 100 may be indexed and angularly retained against rotation by the roller retainer while it is being raised into engagement with web 66. Roller 100 also may be retained against rotation by the roller retainer while it is in engagement with web 66 when in the dynamic mode. Additionally, the web retainer may be actuated to an active state, inhibiting unwinding of web 66 from the web supply as print head(s) 40 contact and/or press against web 66.

Because the extent to which projections 102 of roller 100 extend upward toward and into the path of print head(s) 40 is reduced or minimized, the likelihood of a potentially damaging collision between nozzles 42 of print head(s) 40 and roller 100 also may be reduced. As a result, nozzles 42 of print head(s) 40 may be quickly and effectively serviced as the print head(s) fly by, contact and/or press against the web and/or move across the roller 100.

Because print head(s) 40 may be serviced in transit without stopping or pausing movement of the print head(s), the print head(s) may be serviced more frequently without a substantial reduction in the throughput (output per time) of printing system 20. For example, the print head(s) may be moved to the proximal position in which the print head(s) contact the web during printing of a plot on a printing medium. “During printing,” as used herein, refers to the print head(s) contacting the web at least once after the start of the plot (after the first swath) but before the end of the plot (before the last swath). A plot may include up to 500 swaths or more of the print head(s). The print head(s) may be moved to the proximal position between any suitable number of swaths. For example, the print head(s) may preferably be moved every four swaths, and more preferably every other swath (i.e., every two swaths) to ensure that the print head(s) remain coated and/or that the ink does not crust on the print head(s).

More frequent servicing of nozzles 42 may be beneficial because it is more effective to frequently remove a little bit of wet ink or fluid, such as latex ink, than it is to occasionally remove a greater amount of dried ink or fluid. Additionally, certain types of ink, such as latex ink, may crust or dry if the nozzles are serviced only after the end of the plot. Moreover, the above-noted dynamic mode has not been found to cause or create bubbles in print head(s) 40 and may improve throughput of printing system 20 by reducing a number of times that a static service mode is performed.

The amount of pressure applied by roller 100 (or any other roller) against nozzles 42 of print head 40 may vary depending upon either (1) the height or relative spacing of roller 100 with respect to web 66 and print head(s) 40 and (2) the angular orientation of roller 100. In the static mode 110, the relative spacing is controlled. In the dynamic mode, both the relative spacing and the angle of their orientation may be controlled.

As noted above, roller 100 may be actuatable between two states; an engaged state in which roller 100 engages web 66 and print head(s) 40 and a disengaged state. The profile of roller 100 may be configured such that projections 102 (or other projection configurations) have appropriate dimensions and spacings to provide an enhanced pressure profile for wiping nozzles 42 in both the static mode and the dynamic mode when the roller is positioned in the engaged state. Such a two-state configuration for positioning of roller 100 may reduce cost and complexity of the web actuator. Alternatively, the web actuator may be configured to move roller 100 between multiple positions with respect to print head(s) 40, wherein the roller may engage the Web and/or the print head(s) in multiple positions.

The height or relative spacing between the rotational axis 72 of roller 100 and web 66, as well as print head (s) 40, is substantially constant during actual servicing of the print head(s). In other words, once moved to the engaged position or state, roller 100 may not be substantially translated as web 66 is moved across the roller in the static mode in FIG. 5, or as the print head(s) are moved across roller 100 in the dynamic mode in FIG. 6. Alternatively, the height or relative spacing between the rotational axis 72 of roller 100 and print head(s) 40 may be varied by web actuator 64 during servicing operations.

For example, the spacing of roller 100 with respect to print head(s) 40 may be varied and controlled based upon the angular positioning of the roller as it is being rotated by web 66 during the static made In particular, the angular positioning of the roller, as it is being rotated by movement of the web during the static mode, may be determined using the position of the web, such as from an encoder associated with the web drive. Using the determined positioning of web 66 to determine the angular positioning of roller 100, the controller may generate control signals directing web actuator 64 to adjust, in a synchronous fashion or in an asynchronous fashion, the height or relative positioning of axis 72 of roller 100 with respect to print head(s) 40 during the static mode.

Alternatively, or additionally, the spacing of roller 100 with respect to print head(s) 40 may be varied and controlled based upon the positioning of the print head(s) as those print head(s) are being moved across the roller during the dynamic mode. In particular, the positioning of print head(s) 40 may be determined using one or more sensors which may directly sense the positioning of the print head(s) or which sense motion supplied by the print head actuator Using the determined positioning of print head(s) 40 as they are being moved across roller 100, the controller may generate control signals directing the print head actuator to adjust, in a synchronous fashion or in an asynchronous fashion, the height or relative positioning of roller 100 with respect to print head(s) 40 during the dynamic mode.

FIG. 7 shows a spitting and/or priming mode 130 in which print head(s) 40 may be positioned by the actuator assembly opposite or adjacent to web 66. Roller 100 may be translated by the actuator to a position out of engagement with web 66. Alternatively, roller 100 may remain positioned against web 66. Web 66 may be stationarily supported across the supports or may be moved across those supports during this operation.

Spitting and/or priming may be performed while print head(s) 40 are substantially stationary. In such a mode, the print head(s) may be positioned opposite or adjacent to a portion of web 66 that has already been used for servicing, generally downstream from where roller 100 is directly opposite or adjacent to the web. Consequently, portions of the web that have already been used for servicing, but which may still be absorbent, may be used for priming and spitting. In other embodiments, such priming and spitting may be performed while print head(s) 40 are in transit or are moving across web 66. For example, spitting may be achieved by firing nozzles 42 to eject fluid onto the web. Priming may be performed by supplying pressurized air within print head(s) 40 to force fluid through nozzles 42, which may clear those nozzles of, for example, excess coating from prior maintenance steps. Such priming is generally not impaired by air bubbles that may exist in the firing chambers of the nozzles.

FIG. 8 shows an example of a method, which is generally indicated at 200, of servicing a print head of a printing system. While FIG. 8 shows illustrative steps of a method according to one example, other examples may omit, add to, and/or modify any of the steps shown in FIG. 8.

As illustrated in FIG. 8, the method may include positioning at least one of the print head(s) and a web impregnated with a liquid configured to form a protective coating on the print head proximate each other at 202. The print head(s) and/or the web may be moved toward each other to bring the print head(s) into contact with the web to form the protective coating on the print head(s) at 204. For example, the web may come into contact with and/or be pressed against the print head(s), and/or the print head(s) may come into contact with and/or be pressed against the web. Moving the print head and/or the web toward each other may occur during printing of a plot on a printing medium, such as at least once after the start of the plot but before the end of the plot, or between any suitable number of swaths as discussed above.

Bringing the print head(s) into contact with the web also may clean the print head(s), such as before forming a protective coating on those print head(s). Additionally, where the print head(s) were previously coated and where dried and/or crusted ink may have accumulated on those print head(s), bringing the coated print head(s) into contact with the web may remove the accumulated dried ink and/or the previous protective coating, and/or may form a new protective coating on the print head(s).

Printing system 20 also may include computer-readable media comprising computer-executable instructions for servicing a print head of a printing system, the computer-executable instructions being configured to perform one or more of the steps of method 200 discussed above.

We claim:

1. A printing system, comprising:
a print head;
a web impregnated with a liquid configured to form a protective coating on the print head when the print head contacts the web; and
a roller configured to place the web adjacent the print head, wherein the print head is configured to move among a plurality of positions including a proximal position in which the print head contacts the web, and a distal position in which the print head is spaced from the web.

2. The printing system of claim 1, wherein the web includes a roll of substantially clean and unused wiping material impregnated with the liquid.

3. The printing system of claim 1, wherein the liquid includes a solvent having a boiling point greater than about 200° C.

4. The printing system of claim 3, wherein the solvent includes polyethylene glycol.

5 The printing system of claim 4, wherein the web is impregnated with polyethylene glycol at a concentration of about 0.00714 g/cm² to about 0.025 g/cm².

6. The printing system of claim 1, wherein the liquid is further configured to clean the print head when the print head contacts the web.

7. The printing system of claim 1, wherein the roller is configured to be moved among a plurality of positions including a first position in which the roller brings the web into contact with the print head when the print head is in the proximal position, and a second position in which the roller spaces the web from the print head when the print head is in the proximal position.

8. The printing system of claim 1, wherein the print head is configured to move to the proximal position to contact the web during printing of a plot on a printing medium.

9. A method of servicing a print head of a printing system, comprising
positioning proximate each other at least one of the print head and a web impregnated with a liquid configured to form a protective coating on the print head; and
moving at least one of the print head and the web toward each other to bring the print head into contact with the web to form the protective coating on the print head.

10. The method of claim 9, wherein positioning at least one of the print head and a web includes positioning the print head proximate a web impregnated with a solvent having a boiling point greater than about 200° C.

11. The method of claim 10, wherein positioning the print head proximate a web impregnated with a solvent includes positioning the print head proximate a web impregnated with polyethylene glycol.

12. The method of claim 11, wherein positioning the print head proximate a web impregnated with polyethylene glycol includes positioning the print head proximate a web impregnated with polyethylene glycol at a concentration of about 0.00714 g/cm² to about 0.025 g/cm².

13. The method of claim 97 wherein moving at least one of the print head and the web toward each other occurs during printing of a plot on a printing medium.

14. The method of claim 9, wherein moving at least one of the web and the print head includes moving at least one of the web and the print head to clean the print head and form the protective coating on the print head.

15. Computer-readable media comprising computer-executable instructions for servicing a print head of a printing system, the computer-executable instructions being configured to:
position proximate each other at least of the print head and a web impregnated with a liquid configured to form a protective coating on the print head; and
move at least one of the print head and the web toward each other to bring the print head into contact with the web to form the protective coating on the print head.
